(19) United States
(12) Patent Application Publication
(10) Pub. No.: US 2009/0150200 A1
(43) Pub. Date: Jun. 11, 2009

(54) System and method for generating interpreted damage estimates information

(76) Inventor: Steven Charles Siessman, San Diego, CA (US)

Correspondence Address: Steven Siessman, PO 261084, San Diego, CA, 92196, US

(21) Appl. No.: 12/316,111

(22) Filed: Dec. 9, 2008

Related U.S. Application Data
(60) Provisional application No. 61/005,999, filed on Dec. 10, 2007.

(51) Int. Cl. G06Q 10/00

(52) U.S. Cl. 705/7

(57) ABSTRACT

A method and system for generating interpreted damage estimate information. The steps of generating an interpretation of repair operations consists of selecting a interpretation template from a plurality of interpretation templates, reading a damage estimate file, identifying one or more nomenclature in said damage estimate containing repair operations, determining the sections or groups' contained in said damage estimate file, identifying common section indices for the identified sections or groups, retrieving repair/refinish/replacement parts interpretations that consist of a common section index, related repair/refinish/replacement interpretation, interpreted section header, associated graphical images, and creating a displayable repair interpretation file.

### PRIORITY CLAIM

This application claims the benefit of U.S. Provisional Application No. 61/005,999 entitled “SYSTEM AND METHOD FOR GENERATING TRANSLATED DAMAGE ESTIMATE INFORMATION,” filed Dec. 10, 2007

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of the Invention

The invention relates in general to damage information systems and in particular, to a system and method for interpreting damage repair estimates information.

2. Relevent Art

Computerized systems for creating damage estimates are known. These systems provide access to large amounts of information for part prices, estimated parts replacement labor times and OEM parts prices. An alternate parts database provides OEM/alternate parts sources and prices. These systems provide for a standardized export format that allows damage estimates to be utilized with communications, auditing and other software systems. U.S. Pat. No. 5,432,904 to Wong (1995) and U.S. Pat. No. 5,504,674 to Chen, et al (1996) disclose a method for selecting a graphic then individually selecting a part to add to a damage estimate, forcing users to create damage estimates a part or operation at a time. U.S. Pat. No. 6,185,540 to Schreitmueller, et al (2001) discloses a method of “drilling into” layers of a vehicle related to damage zones allowing users to see parts in various related layers and to select a part from a hot spot to add to a damage estimate, again forcing users to select individual parts in layers. U.S. Patent Application 20060064393 to Orr (Sep. 24, 2004) discloses a method for automatically generating vehicles damage estimates. This generation method requires users to manually select a single part or part subgroup and then select the related operation to perform. Only after all parts or parts groups are manually identified by the user can a damage estimate be generated. Generation consists of adding selected parts or assemblies to the estimate, performing arithmetic calculations such as adjusting labor times for overlapping panels, adding non-included operations associated with selected parts or parts groups and calculating the damage estimate total cost.

Computerized vehicle history reporting systems as known. Carfax is the best know company providing an electronic vehicle history report for used vehicles. U.S. Pat. No. 7,113,853 to Hecklinger (2006) and U.S. Patent Application 20060178793 to Hecklinger (Jul. 16, 2003) disclose a method for generating vehicle history related to manufacturer buyback, recall and title status.

Computerized systems for capturing damaged vehicle images are known. These systems provide access to photographs of vehicles. U.S. Pat. No. 5,128,859 to Carbone et al (Jul. 7, 1992) discloses a system for capturing and annotating vehicle repair images at certain milestones for use in damage estimate reporting. U.S. Pat. No. 5,504,674 to Chen, et al (1996) discloses capturing and transmitting vehicle damage images to insurance companies. U.S. Pat. No. 7,151,448 to Henderson et al (Dec. 19, 2006) discloses a method for capturing vehicle repair images for use by vehicle owners.

Generated damage estimates are exploded bill of materials containing parts descriptions and prices, labor operations times and prices, materials costs and other line information. This exploded bill of materials contains industry specific nomenclature and individual parts information. For example, if a hood is repaired the estimate may include the hood panel, hinges, striker plate, and locks and associated hardware. While the exploded bill of materials is useful for ordering parts and organizing the work flow it may be confusing to read and may not adequately provide clear information. For example, a damage estimate may not clearly indicate to a vehicle owner that a structural area of their vehicle was repaired because the line item nomenclature used, “Hinge Pillar”, “Center Reinforcement” or “Uniside Assembly” is meaningless to the lay person. In addition, damage estimates may contain multiple line items associated with a single area of a vehicle. Property owners, repair technicians, vehicle manufacturers, body repair shops, financing entities, insurance companies and others may desire associated repair estimates' line items interpreted to their specific requirements. For example, property owners may desire a damage estimate to be interpreted to common non-technical English, another language or graphical representations as to make it understandable by them in evaluating multiple damage estimates, understanding pre and post repair condition of their property, or in making other decisions based on damage estimate content. Financing companies may desire a non-technical damage interpretation to assist them in determining what to do with damaged property. Body repair shops may desire to generate an interpreted damage estimate that consolidates related parts, labor operations and materials into non-technical summaries with supporting illustrations for marketing to vehicle owners. Vehicle manufactures may desire to provide warranty, repair procedures, or other information for particular vehicle sections or groups, such as aluminum or high strength boron steels, or for a particular section of a vehicle such as quarter panel. Insurance companies may desire to provide interpreted estimates to their insured for warranty clarification or other reasons, or to internal staff to standardize adjusting procedures. Or any other entity may desire a particular damage estimate interpretation relating to their individual interpretation requirements.

### OBJECTS AND ADVANTAGES

It is, therefore, one advantage of the present invention to overcome the deficiencies of the prior art by providing a system and method capable of efficiently and effectively generating an interpretation of repair operations contained in particular damaged repair estimate sections or groups.

Another advantage of the present invention to overcome the deficiencies of the prior art by providing a system and method capable of efficiently and effectively generating an interpretation of refinish operations contained in particular damaged repair estimate sections or groups.

Another advantage of the present invention to overcome the deficiencies of the prior art by providing a system and method capable of efficiently and effectively generating an interpretation of replacement parts contained in particular damaged repair estimate sections or groups.

Another advantage of the present invention is to overcome the deficiencies of the prior art by providing a system and method capable of efficiently and effectively associating graphical images relating to repair operations' interpretations.

Another advantage of the present invention is to overcome the deficiencies of the prior art by providing a system and method capable of efficiently and effectively associating graphical images relating to refinish operation's interpretations.

Another advantage of the present invention is to overcome the deficiencies of the prior art by providing a system and method capable of efficiently and effectively associating graphical images relating to replacement parts' interpretations.

Another advantage of the present invention is to overcome the deficiencies of the prior art by providing a system and method capable of efficiently and effectively associating images to particular interpreted sections or groups at various phases of the repair process.

Another advantage of the present invention is to overcome the deficiencies of the prior art by providing a system and method capable of efficiently and effectively calculating and displaying replacement parts and costs relating to particular sections or groups.

Further objects and advantages are storing and displaying information relating to generating interpreted damage estimates. Still further objects and advantages will become apparent from a consideration of the ensuing description and drawings.

The above objects and advantages, and other objects and advantages, are achieved by providing methods and systems for generating an interpretation of repair operations, generating an interpretation of refinish operations, generating an interpretation of replacement parts, associating images with interpreted sections or group, calculating replacement parts costs associated with particular sections or groups, generating interpreted sections or groups header information, and obtaining damage estimate interpretation information.

The steps of generating an interpretation of repair operations consists of selecting a interpretation template from a plurality of interpretation templates, reading a damage estimate file, identifying one or more nomenclature in said damage estimate containing repair operations, determining the sections or groups' contained in said damage estimate file, identifying common section indices for the identified sections or groups, retrieving repair interpretations that consist of a common section index, related repair interpretation, interpreted section header, associated graphical images, and creating a displayable repair interpretation file.

The steps of generating an interpretation of refinish operations consists of selecting a interpretation template from a plurality of interpretation templates, reading a damage estimate file, identifying one or more nomenclature in said damage estimate containing refinish operations, determining the sections or groups' contained in said damage estimate file, identifying common section indices for the identified sections or groups, retrieving refinish interpretations that consist of a common section index, related refinish interpretation, interpreted section header, associated graphical images, and creating a displayable refinish interpretation file.

The steps of generating an interpretation of replacement parts consists of selecting a interpretation template from a plurality of interpretation templates, reading a damage estimate file, identifying one or more nomenclature in said damage estimate containing replacement parts, determining the sections or groups' contained in said damage estimate file, identifying common section indices for the identified sections or groups, retrieving replacement parts interpretations that consist of a common section index, related replacement parts interpretation, interpreted section header, associated graphical images, and creating a displayable replacement parts interpretation file.

The steps of calculating sections or groups' replacement parts costs consist of reading a damage estimate file, identifying line descriptions containing replacement parts, creating sets of line descriptions relating to particular sections or groups, and summing parts prices for particular sections or groups.

The steps of displaying information consist of retrieving electronically displayable files and other associated information, and consolidating the displayable files and other associated information into a report and displaying the report on an electronic viewing device.

### SUMMARY

In accordance with the present invention methods and systems for generating interpreted damage estimate repair information, generating interpreted damage estimate refinish information, generating interpreted damage estimate replacement parts information, associating images with sections or group interpretations, calculating sections or groups replacement parts costs, and displaying information.

### BRIEF DESCRIPTION OF THE DRAWINGS

FIG. 1 is a schematic representation of the system of the present invention showing the relationship of different entities using the system;

FIG. 2 is a schematic diagram of the computer system of the present invention for generating interpreted damage estimate information;

FIG. 3 is flow diagram of the method of the present invention showing the steps for aggregating damage estimate section or group information;

FIG. 4 is a user interface display of an electronically displayable file showing a page for uploading a damage estimate;

FIG. 5 is a user interface display of an electronically displayable file showing a damage estimate interpretation.

### DETAILED DESCRIPTION

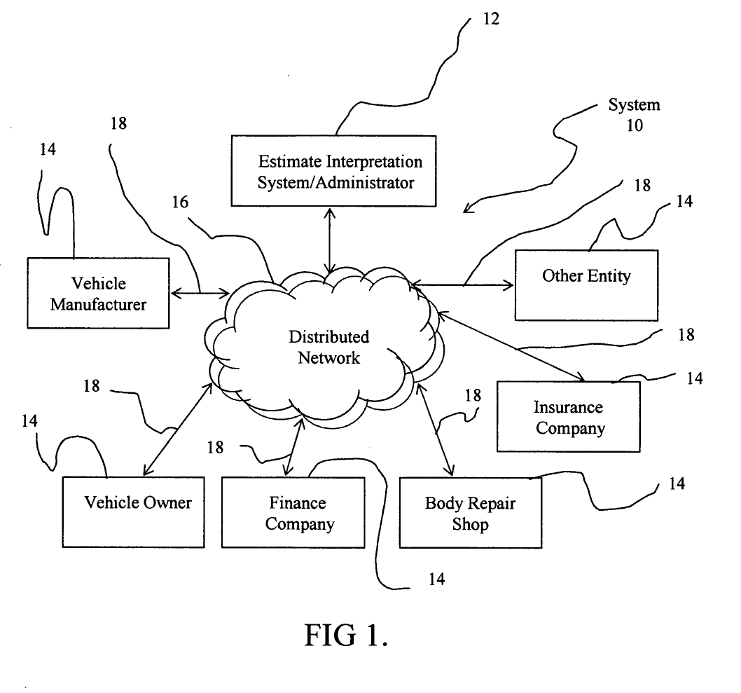

Referring to the drawings, FIG. 1 is a highly schematic diagram of a system, for example in the form of a computer network 10, designed to implement the subject invention. FIG. 1 may also be viewed as showing the relationship of the different entities potentially involved in the application of one embodiment of the present invention. Specifically, a computer implemented damage estimate association system 12 exchanges data with a plurality of remote terminals 14 through data transmission across a distributed network 16, e.g. Internet. The terminals 14 represent individual vehicle owners, financial institutions, insurance companies, independent adjusters, loan co-signers, body repair shops, vehicle manufacturers and other entities accessing estimate notification system 12, as discussed more fully herein below, to upload damage estimates, receive notification, obtain estimate analysis results and obtain consolidated management reports.

The distributed network 16 may be any type of communications channel such as a local area network (LAN), wide area network (WAN), direct computer connections, and/or wireless connections using radio frequency, infrared, or other wireless technologies using any appropriate communication hardware and protocols, and may further be the Internet. Thus, terminals 14 may be connected to distributed network 16 by any conventional communication links 18, including hardwired and/or wireless.

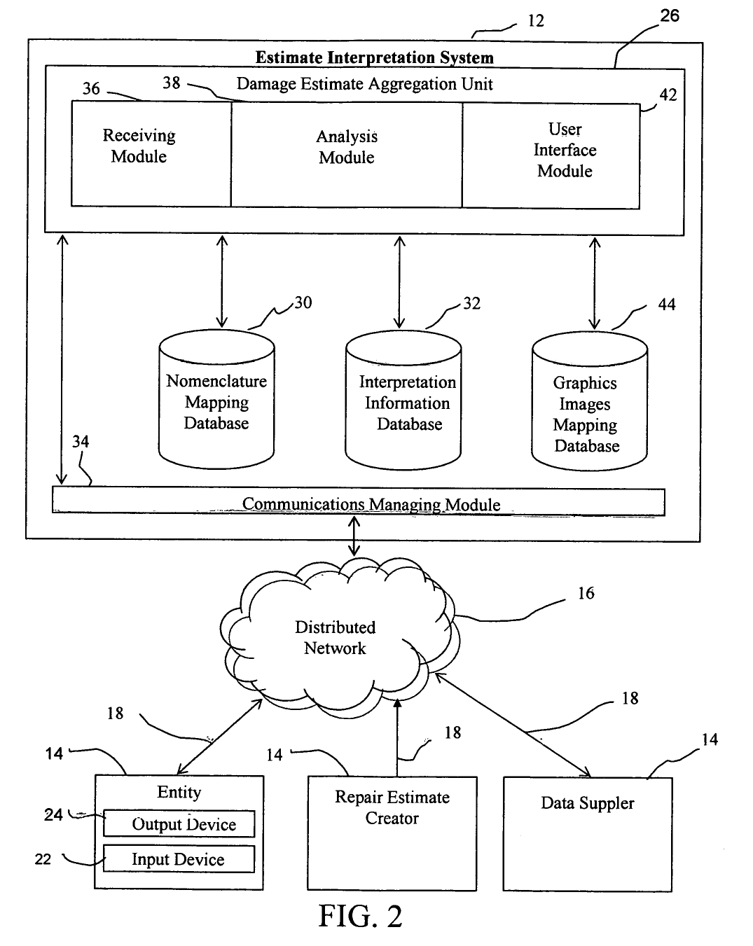

Referring to FIG. 2, in the embodiment, estimate interpretation system 12 includes a damage estimate analysis unit 26, a nomenclature mapping database 30, an interpretation information database 32, a graphics image database 44, a data communications module 34, all of which are connected together for effective data communication. Damage estimate interpretation unit 26 specifically includes a receiving module 36, an analysis module 38, and a user interface module 42.

It should be noted that the estimate interpretation system 12 and the damage estimate interpretation unit 26 in accordance with the embodiment of the present invention is illustrated and discussed herein as having various modules and units which perform particular functions. It should be understood that these modules and units, including the file server and databases, are merely schematically illustrated based on their function for clarity purposes, and do not necessarily represent specific hardware or software. In this regard, these modules, units and other components may be hardware and/or software implemented to substantially perform their particular functions explained herein. The various functions of the different components can be combined or segregated as hardware and/or software modules in any manner, and can be useful separately or in combination. Thus, the present invention as schematically embodied in FIG. 2 should not be construed to limit the estimate interpretation system 12 of the present invention, but be understood to merely be a schematic example.

The nomenclature mapping database 30 may contain a comprehensive collection of vehicle sections or groups codes, organized, indexed and/or retrievable based on damage estimate sections or groups descriptions and template name. A sections or group code is a non-unique interpretation information identifier code used to select records in the interpretation information database 32 and graphics images mapping database 44.

As previously mentioned, the administrator of estimate interpretation system 12 acquires nomenclature mapping data from a variety of data suppliers 14. Each item of data acquired and entered into damage nomenclature mapping database 30 may be indexed by unique sections or groups descriptions and template name. A nomenclature mapping consists of the record for a specified section or group description, template name, and associated sections or group code. For example a nomenclature mapping may consist of the record retrieved with an index of “REAR FLOOR, PILLARS & ROCKER PANEL”, “SPANISH VAN”, or “REAR FLOOR, PILLARS & ROCKER PANEL”, “SPANISH SUV” or “REAR FLOOR, PILLARS & ROCKER PANEL”, “MERCEDES ” or “REAR FLOOR, PILLARS & ROCKER PANEL”, “PPG PAINT” or “REAR FLOOR, PILLARS & ROCKER PANEL”, “ALLSTATE INSURANCE” or “REAR FLOOR, PILLARS & ROCKER PANEL”, “ALUMINUM REPAIR PROCESS”.

The interpretation information database 32 may consist of a comprehensive collection of sections or groups interpretation information, organized, indexed and/or retrievable based on sections or groups codes. Interpretation information may be the set of interpretation information for labor, refinish, and replacement parts indexed by sections or groups codes. For example interpretation information may consist of all the records for a specified sections or group code of “1”.

The graphics images mapping database 44 may consist of a comprehensive collection of images organized, indexed and/or retrievable based on sections or groups codes and section/group type. Graphic images relate to labor, refinish, replacement parts subsections, and main sections or groups headings. For example, a graphics images mapping for sections or groups code “3” may consist of the records retrieved with the index 3, “3”, “LABOR SUBSECTION”, “IMAGE011 .JPG”, “3”, “REFINISH SUBSECTION”, “IMAGE021.JPG”, “3”, “REPLACEMENT PARTS SUBSECTION”, “IMAGE031.JPG”, “3”, “MAIN SECTION HEADER”, “IMAGE041.JPG”.

Nomenclature mapping database 30, interpretation information database 28, graphics images mapping database 44 may be any conventional database capable of effectively storing collections of records in an organized accessible manner to permit efficient easy access to desired pieces of data, i.e. one or more records, for example, associated with a particular index, using appropriate database management system software.

In one embodiment, a damage estimate interpretation unit 26 includes appropriate hardware and software for implementing the various modules and functions necessary to perform the functions of the estimate interpretation system described herein. Damage estimate interpretation unit 26 may be a general purpose computing device with a central processing unit (CPU) or processor. The software of unit 26 and of the various modules within unit 26 resides in a computer readable storage medium in the form of encoded executable instructions for operating the system and performing the functionalities and process steps described herein.

Receiving module 36 functions to receive an estimate file uploaded from a repair facility, insurance office or other source of estimate files. Thus, module 36 includes the appropriate software necessary to import estimate file(s) and organize the uploaded estimate information in a manner appropriate for further data processing. Information extracted and organized from the estimate file consists of the owner information, vehicle identification number, estimate line descriptions, estimate totals, and section information.

Interpretation module 38 functions to create the interpreted damage repair estimate from the uploaded estimate using nomenclature mappings, interpretation information and graphical images for a selected template. Interpretation consist of determining the estimating system vendor, retrieving records from nomenclature mapping database 30 relating to a specific estimating system vendor and template, said records containing information relating to interpretation section descriptions and section or group code, determining sections or groups contained in a retrieved damage estimate, determining sections or groups codes relating to identified sections or groups for a specified template, retrieving records from interpretation information database 32 relating to identified groups or sections codes, said records containing interpretation labor overviews, interpretation refinish overviews and interpretation replacement parts overviews, retrieving records from graphics images mapping database 44 relating to identified groups or sections codes, said records containing graphic file identifiers, calculating the sum of replacement parts in said damage estimate relating to groups or sections codes, identifying replacement parts descriptions in said damage estimate relating to groups or sections codes, identifying replacement parts types (new, used, aftermarket, etc) in said damage estimate relating to groups or sections codes, and generating the interpretation damage estimate

Importantly, damage estimate interpretation unit 26 includes interpretation module 38 which is adapted to execute particular process steps including identifying sections or groups in estimates, identifying interpretation section descriptions and graphical images, identifying individual interpretation information graphics, calculating interpretation section replacement parts prices, identifying and categorizing replacement parts contained in interpretation sections and creating individual interpretation sections or groups. As used herein, aggregating preferably refers to identifying and associating information and graphics relating to sections or common groups in damage estimates. Examples of interpreted damage estimate are creating multi-lingual summaries related to vehicle sections or groups, associating repair methods, warnings or practices to specific vehicle sections, associating specialized instructions for technicians, or associating parts type warnings in sections or groups.

User interface module 42 is adapted to utilize the information provided by interpretation module 38 to generate a user interface for delivery to output device 24 of terminal 14. User interface module 42 may be in the form of a file server with appropriate software capable of generating particular electronically displayable files for delivery to, and display by, output device 24 of terminal 14. Alternatively, the electronically displayable files may be stored in a separate file server within estimate interpretation system 12 or may reside on a remote server to which the estimate interpretation system 12 is connected. Communications managing module 34 is adapted to manage communications and interactions between estimate interpretation system 12 and its various components, and with the various terminals 14 via the distributed network 16.

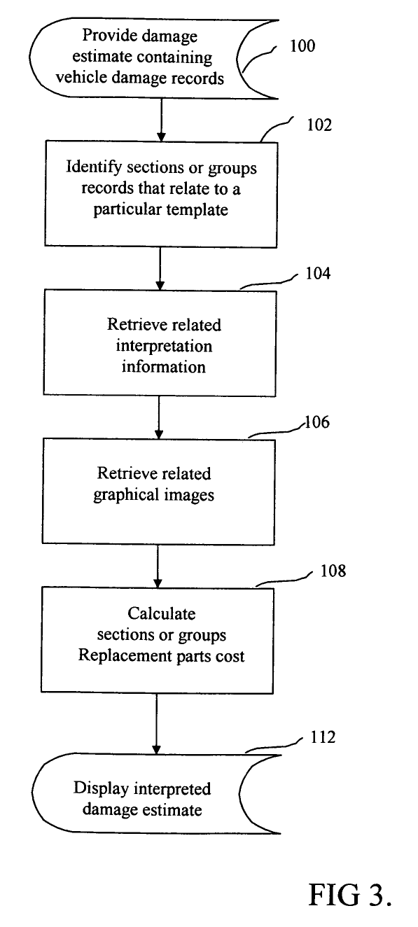

Referring to FIG. 3, a general representation of the method for aggregating damage estimate information, corresponding to the system of the present invention of FIG. 2, is illustrated in the form of a flow diagram starting with step 100 in which interpretation information database 32, nomenclature mapping database 30, and graphics images mapping database 28, containing labor overview information, refinish overview information, replacement parts information, nomenclature mappings and graphics files, is provided by, for example, the estimate interpretation system administrator.

Next, in step 102, receiving module 36 receives and extracts damage estimate information from a damage estimate file, and interpretation module 38 determines sections and groups codes and interpretation sections or groups titles using nomenclature mapping database 30 for use in aggregating damage information. Specifically, interpretation module 38 retrieves records from nomenclature mapping database 30 relating to extracted section information for a specified template. More than one section may share the same sections or groups index. For example, “Wheels” and “Front Suspension” and “Rear Suspension” may share the same section or group code and title relating to a specified template, “104”, “Montura de Objetivo Frontal con fijación para filtro”. Typically, step 102 is performed in response to an estimate being uploaded by a repair estimate creator 18 to estimate interpretation system 12. Specifically manufacturer's line descriptions, repair operations, replacement parts types and prices, total labor cost, total parts cost, sales tax, sublet/miscellaneous charges, and sections and groups identifiers are extracted from the damage estimate and temporarily stored. In addition, owner and vehicle information consisting of the vehicle owner name, vehicle identification number, vehicle year, make and model, mileage, photographs or other graphical images of vehicle damage are extracted from estimate files and temporarily stored. In the embodiment, an estimate is uploaded to a website permitting simple, automated communication between the repair estimate creator 18 and estimate interpretation system 12 via distributed network 16.

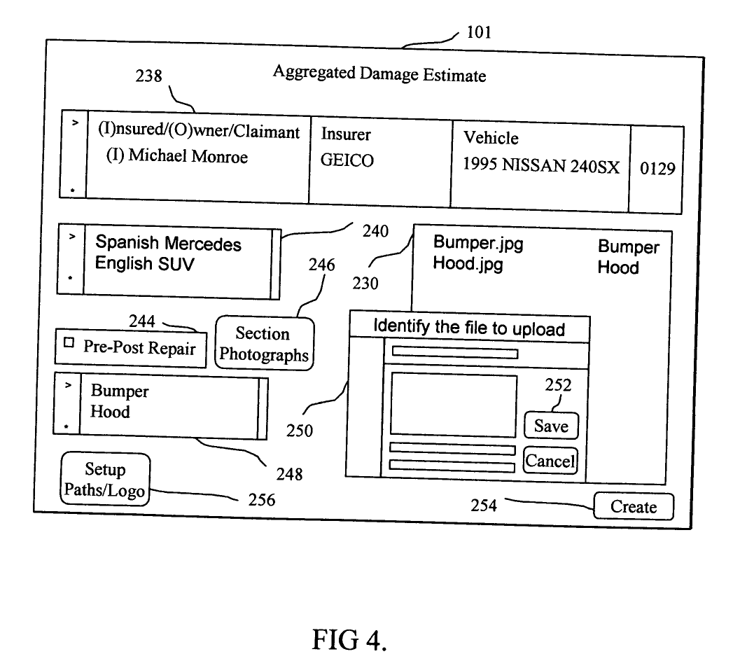

For example, as shown in FIG. 4, an electronically displayable file including a user interface 101, in the form of an output screen, is displayed on the output device 24 of the customer's terminal 14. Repair estimate creator 14 selects the damage estimate to aggregate using estimate selection grid 238. Then a interpretation template is selected using template selection grid 240. Pre-Post Repair checkbox 244 is selected if the interpretation damage estimate contains pre and post repair images in place of pre-defined section or group graphic images. If Pre-Post Repair checkbox 244 is checked the repair estimate creator 14 selects a section or group relating to a photograph using section selection grid 248 and then selects section photographs button 246. Next image dialog box 250 is used to browse for a photograph or image. Save button 252 is selected to append the photograph or file name and associated section description in image section list box 242. Then, the repair estimate creator 14 initiates the estimate interpretation using “Create” button 254. If Pre-Post Repair checkbox 244 is not checked repair estimate creator selects “Create” button 254 after selecting the damage estimate and interpretation template. Repair estimate creator identified a report logo and estimate folder locations selecting “Setup Paths/Logo” button 256. The upload request is received by estimate interpretation system 12 via communications managing module 34, which processes the request utilizing damage estimate interpretation unit 26. Specifically, interpretation module 38 processes the request by selecting all records in nomenclature database 30, interpretation information 32, and graphics images mapping database 44 relating to a particular template and estimating system vendor as represented by step 102 of FIG. 3. Of course, other files may be displayed to the user for inputting contact information, payment information or other information to allow appropriate processing.

Next, in step 104, interpretation module 38 retrieves records from interpretation information database 32 relating to sections or groups codes determined in step 102. Specifically, records containing labor overview information, refinish overview information, and replacement parts information are retrieved relating to identified sections or groups codes. Then, analysis module 38 creates the interpretation labor, interpretation refinish and interpretation replacement parts information text subsections of the displayable file relating to specific sections or groups.

Next, in step 106, interpretation module 38 retrieves records from graphics images mapping database 44 relating to sections or groups codes determined in step 102. Specifically, records containing graphics file names relating to sections or groups codes and interpretation labor, interpretation refinish and interpretation replacement parts overviews. For example, records are retrieved for sections or group index “99”, LABOR SUBSECTION, “99”, “REFINISH SUBSECTION”, “99”, “REPLACEMENT PARTS SUBSECTION”, “99”, “MAIN SECTION HEADER”. Then, analysis module 38 creates the interpretation labor, interpretation refinish, interpretation replacement parts information, and main sections or groups title graphics subsections of the displayable file relating to sections or groups codes.

Next, in step 108, interpretation module 38 calculates the replacement parts cost relating to sections or groups codes. Specifically, interpretation module 38 identifies line descriptions with replacement parts in said damage estimate. Then, interpretation module 38 determines sections or groups associated with said line descriptions. Then interpretation module 38 calculates the total replacement parts cost relating to particular sections or groups. For example, “99”, $761.50 representing total replacements parts cost of $761.50 for sections or group code 99. Then, analysis module 38 creates the replacement parts detail subsections of the displayable file relating to sections or groups codes.

Next, in step 112 interpretation module 38 initiates a command for the storage of a displayable interpretation estimate file for the particular damage estimate then user interface module 42 initiates the transmission of a interpretation estimate file from system 12, or a file server on the distributed network 16, to customer terminal 14 for display on output device 24.

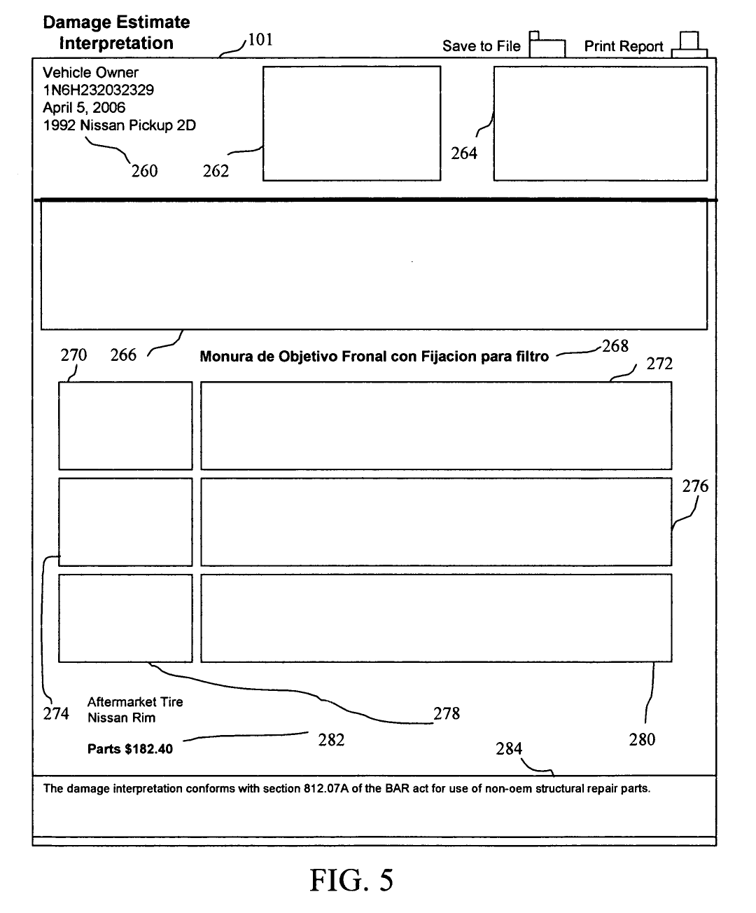

For example, referring to FIG. 5, an electronically displayable file in the form of a user interface 101 showing a report summary may include vehicle, customer and insurance informat0ion 260, repair estimate creator logo or other graphical image pane 262, customer photograph or other graphical image pane 264, associated main section header graphics pane 266, associated section or group title 268, associated labor overview images pane 270, associated labor overview text display 272, associated refinish overview images pane 274, associated refinish overview text display 276, associated replacement parts overview images pane 278, associated replacement parts overview text display 280, replacement parts detail subsection 282, and damage estimate disclaimer 284.

Entity 14 may retrieve and display a particular stored displayable interpretation estimate file using user interface module 42 to initiate the transmission of an interpreted estimate file from system 12, or a file server on the distributed network 16, to customer terminal 14 for display on output device 24.

What is claimed is:

1. A method for generating interpreted damage estimate information, comprising the steps of identifying a particular interpretation template; receiving a damage estimate; identifying records in a database that relate to nomenclature, said records containing data relating to groups or sections related to particular nomenclature, said database having records of nomenclature related to a section or group for a plurality of nomenclature; identifying nomenclature contained in both said damage estimate and said database determining sections or groups contained in said damage estimate; identifying records in a database relating to interpretations related to sections or groups for a particular interpretation template, said records containing data relating to interpretations related to a particular section or group, said database having records of interpretations for a plurality of interpretation templates; identifying interpretations for sections or groups identified in said damage estimate for a particular interpretation template; and creating an electronically displayable interpreted damage estimate information file.

2. The method of claim 1, further including calculating replacement parts costs relating to particular interpreted sections or groups.

3. The method of claim 1, further including associating graphical images relating to particular interpreted sections or groups.

4. The method of claim 1, further including displaying an electronically displayable file relating to a particular interpreted damage estimate.

5. A computer system for generating interpreted damage estimate information, including: a receiving module used to receive a damage estimate; an interpretation module coupled to a database for use in generating interpreted estimate information; and a user interface module adapted to receive a user request for generating an interpreted damage estimate related to a particular damage estimate.
